(19) United States
(12) Patent Application Publication
(10) Pub. No.: US 2019/0340708 A1
(43) Pub. Date: Nov. 7, 2019

(54) METHOD FOR THE USAGE PLANNING OF AN ELECTRICAL SYSTEM FOR SUPPLYING ENERGY

(71) Applicant: Maschinenfabrik Reinhausen GmbH, Regensburg (DE)

(72) Inventor: Karsten Viereck, Regensburg (DE)

(21) Appl. No.: 16/479,956

(22) PCT Filed: Jan. 17, 2018
(86) PCT No.: PCT/EP2018/051066

§ 371 Date: Jul. 23, 2019

(30) Foreign Application Priority Data
Jan. 25, 2017 (DE) 10 2017 101 413.6

(51) Int. Cl. G06Q 50/06; G06Q 10/06

(52) U.S. Cl. CPC G06Q 50/06; G06Q 10/0631

(57) ABSTRACT

A method provides for usage planning of electrical operating equipment of an electrical system. Here, a future instant is predetermined. Also, for each of the electrical operating equipment: first and second parameter data respectively describing its technical nature and relevance are determined; its characteristic value data are determined; its predicted state index representing its predicted state for the future instant is determined using a first mathematical rule from its first parameter data and its characteristic value data; its criticality index is determined using a second mathematical rule from its second parameter data; and its expanded state index representing its predicted risk analysis is determined using a third mathematical rule from its state index and its criticality index. For the electrical system, a predictive assessment of stability and/or serviceability for the future instant is carried out on the basis of the expanded state index.

### CROSS-REFERENCE TO PRIOR APPLICATIONS

This application is a U.S. National Stage Application under 35 U.S.C. § 371 of International Application No. PCT/EP2018/051066 filed on Jan. 17, 2018, and claims benefit to German Patent Application No. DE 10 2017 101 413.6 filed on Jan. 25, 2017. The International Application was published in German on Aug. 2, 2018, as WO 2018/137980 A1 under PCT Article 21(2).

### FIELD

The present invention relates to usage planning of operating means of an electrical system for energy supply.

### BACKGROUND

Electrical systems for supplying energy include a plurality of operating means such as, for example, overhead lines, transformers, switching systems, reactive power compensation systems, filters and systems for uninterrupted power supply (UPS).

Important variables for usage planning of these operating means include, inter alia, the serviceability of the electrical system and the stability of the electrical system.

The serviceability of the electrical system is regarded in the following to be the time per year in which this system is used in accordance with its constructional intention. Serviceability is impaired primarily by voltage interruptions due to mains failures or disruptions of the electrical system.

The stability of the electrical system is regarded in the following to be the capability thereof, for a given initial operating state, to recover an equilibrium operating state after a disturbance, wherein most variables are limited and virtually the entire system remains intact.

In order to ensure a highest possibility serviceability and stability, the operators of such systems are obliged to fulfil various requirements. The most important of these requirements is the so-called (N-x) criterion, which states that in the case of failure of a number x of operating means of the system the operation or the functional capability of the entire system must be reliably guaranteed.

WO 2004 090 764 A1 describes a method for systematic assessment and classification of technical operating means by way of a data processing device, wherein in steps:
at least one first data set with economically relevant input characteristic values and at least one second data set with technically relevant input characteristic values are detected and/or determined for the respective technical operating means,
for each data set the determined input characteristic values are combined to form, respectively, an economic assessment characteristic value Flx and a technical assessment characteristic value Rlx by knowledge-based predetermined numerical and/or logical links as well as knowledge-based weighting factors specific to operating means, and
resulting from the determined assessment characteristic value, by knowledge-based predetermined numerical links and weighting factors a single overall assessment characteristic value EIx for validation of the respective technical operating means is determined.

On the basis of this overall assessment value Elx the system is usable for systematic state evaluation of operating means in heavy-current technology, particularly of transformers.

The input characteristic values or data respectively associated with the technically relevant or technical input characteristic values ordinarily reproduce the best-possible subjective estimation of the respective assessor and/or user and are critically based on the expert knowledge and/or experience thereof. The input data, which are required for determination of the economic assessment characteristic value of the respective technical operating means, of the economically relevant input characteristic values can be determined by estimation based on experience and/or technical/commercial considerations and/or in comparison with the technical input characteristic values.

WO 2009 042 258 A1 describes a method for intelligent monitoring and management of an electrical system, including:
a data detecting component communicatively connected with a sensor configured to detect real-time data of the electrical system;
a performance analytics server communicatively connected with the data detecting component, including:
an engine for virtual modelling of the system, which is configured to produce for the electrical system a prediction data output with use of a virtual system model of the electrical system;
an analysis engine which is configured to monitor the real-time data output and the prediction data output of the electrical system and additionally configured to initiate a calibration and synchronisation operation in order to update the virtual system model if a difference between the real-time data output and the prediction data output exceeds a threshold value;
a real-time engine for a reliability index of the electrical system, which is configured to compute real-time values of a system reliability index on the basis of data, which are generated from the virtual system model, of stability indices; and
a client terminal which is communicatively connected with the performance analytics server and which is configured to display the system reliability index.

An ‘ageing of the virtual model synchronously with the actual network’ is ensured by this method. In addition, a learning software is filed, which recognises and evaluates patterns and based thereon can undertake estimations of the development of parameters of the electrical system.

If additional input parameters are added to the virtual model then it is possible to take into consideration failure rates, repair frequency, failure costs, etc., in the system analysis. The thus-generated virtual model expanded by addition parameters with respect to serviceability is used to generate appropriate handling recommendations for network control.

### SUMMARY

An embodiment of the present invention provides, a method for usage planning of electrical operating equipment of an electrical system for supplying energy. In the method, a future instant is predetermined. Also, for each of the electrical operating equipment: first parameter data describing the technical nature of the respective electrical operating equipment are determined; second parameter data describing the relevance of the respective electrical operating equipment in comparison with the remaining electrical operating equipment are determined; characteristic value data of the respective electrical operating equipment are determined; a predicted state index representing a predicted state of the respective electrical operating equipment for the future instant is determined using a first mathematical rule from the first parameter data and the characteristic value data of the respective electrical operating equipment; a criticality index is determined using a second mathematical rule from the second parameter data of the respective electrical operating equipment; an expanded state index representing a predicted risk analysis of the respective electrical operating equipment is determined using a third mathematical rule from the state index and the criticality index of the respective electrical operating equipment. For the electrical system, a predictive assessment of stability and/or serviceability for the future instant is carried out on the basis of the expanded state index.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows a network node of an energy supply network;

FIG. 2 shows an energy supply network with network nodes according to FIG. 1;

FIG. 3 shows method steps for optimised usage planning of the energy supply network; and

FIG. 4 shows method steps for determining an expanded state index for operating means of the energy supply network.

### DETAILED DESCRIPTION

According to an aspect of the present invention, a method is provided for usage planning of operating means of an electrical system for energy supply, wherein
a future instant is predetermined;
for each operating means
   first parameter data describing the technical nature of the respective operating means are determined;
   second parameter data describing the relevance of the respective operating means in comparison with the remaining operating means are determined;
   characteristic value data of the respective operating means are determined;
   a predicted state index HIᵢ representing the predicted state of this operating means for the future instant is determined with the help of a first mathematical rule from its first parameter data and its characteristic value data;
   a criticality index CIᵢ is determined with the help of a second mathematical rule from its second parameter data;
   an expanded state index RIᵢ representing a predicted risk analysis of this operating means is determined with the help of a third mathematical rule from its state index HIᵢ and its criticality index CIᵢ;
for the electrical system
   a predictive assessment of the stability and/or serviceability for the future instant is carried out on the basis of the expanded state index RIᵢ.

According to an aspect of the invention, an electrical system is provided for energy supply, including:
a plurality of operating means such as, for example, transformers, power switches, isolating switches, power lines;
a control system, which is coupled to the operating means,
   wherein the control system is so constructed that it can execute a method for usage planning of the operating means, in accordance with which it
predetermines a future instant t+Δt;
for each operating means
determines first parameter data SP describing the technical nature of the respective operating means;
determines second parameter data KP describing the relevance of the respective operating means compared with the remaining operating means;
determines characteristic value data DP of the respective operating means;
determines a predicted state index HIᵢ, which represents the predicted state of this operating means for the future instant, with the help of a first mathematical rule from its first parameter data and its characteristic value data;
determines a criticality index CIᵢ with the help of a second mathematical rule from its second parameter data;
determines an expanded state index RIᵢ, which represents a predicted risk analysis of this operating means, with the help of a third mathematical rule from its state index HIᵢ and its criticality index CIᵢ;
for the electrical system
performs a predictive assessment of the stability and/or serviceability for the future instant on the basis of the expanded state index RIᵢ.

The invention makes possible an operating management, which is optimised by comparison with the known prior art, and usage planning of operating means of an electrical system in that current and time-based prediction data of the corresponding operating means are incorporated in the planning and computation models with respect to operating management and usage planning and thus a dynamic network computation based on mathematical models such as, for example, ageing models is possible.

As shown, already existing on the plane of the respective operating means population, such as, for example, transformer population, overhead line population or switching system population, are approaches to analyse the state and the failure probability of an operating means or a plurality or group of operating means and to derive handling recommendations. By contrast, the computation methods or procedures for serviceability computation and reliability of the (N−1) criterion previously did not use a time-dependent statement with respect to serviceability of an operating means in the energy supply system. A time-dependent consideration, for example a prediction computation how long an operating means based on its previous utilisation remains serviceable and the resulting consequences on the stability of a system, is currently not used within the scope of network and serviceability calculation.

The operating means (or electrical supply infrastructure or electrical operating equipment) include, for example, at least one transformer and/or at least one electrical line (executed as an overhead line or subterranean cable) and/or at least one switching system and/or at least one filter and/or at least one reactive power compensation system and/or at least one system for uninterrupted power supply and/or further elements of the electrical energy supply.

The electrical system is, for example, an energy supply mains, the electrical lines, such as overhead lines or subterranean cables, and the associated equipment such as switching mechanisms, network nodes—also termed electric power substations or substations—and the power stations and consumers connected therewith.

The parameter data are values which are almost constant in the course of time and can therefore be considered to be approximately static values. Detection once or repeated merely at large intervals in time is thus sufficient. Parameter data can be, for example, rated performance or rated voltage of an operating means or costs for operating means exchange. Parameter data which do not change at all in the course of time include, for example, open-circuit voltage and short-circuit voltage of the transformer, rated performance and maximum short-circuit current. Parameter data which change only very slowly in the course of time include, for example, such which are detected during annual routine maintenance, for example data from off-line oil analysis (off-line DGA) thereof, which allow a conclusion about the oil quality of the transformer.

On the other hand, the characteristic values are values which are subject to fluctuations over time and thus can be regarded as dynamic values. They therefore need continuous or repeated detection. Characteristic values can be, for example, temperatures, electrical performance, electrical currents or electrical voltages.

The future instant can be a fixed instant in the future or can be defined on the basis of a predetermined time period referenced to a starting point.

In one form of embodiment of the invention it is specified that:
an adapted usage planning of the operating means is produced from the predictive assessment;
handling recommendations for operating management of the electrical system are produced on the basis of the usage planning.

In one form of embodiment of the invention it is specified that:
physical risk groups including the mechanics and/or thermics and/or dielectrics and/or tap changer and/or bushing and/or cooling and/or further groups are formed for creating the first mathematical rule;
specific mathematical models for state analysis and characterisation are used for forming the individual risk groups.

In one form of embodiment of the invention it is specified that:
the first mathematical rule includes a thermal ageing model of a transformer or of an overhead line and/or rules for modelling the mechanical load in a transformer and/or rules for DGA analysis.

In one form of embodiment of the invention it is specified that:
the characteristic values of a transformer include the load current, the temperature of the transformer insulating oil and/or the ambient temperature and/or the gas concentration in the insulating oil of the transformer and/or the instantaneous performance of the transformer.

In one form of embodiment of the invention it is specified that
the scanning rates between two measuring instants for determination of parameter data are greater by several orders or magnitude than the scanning rates between two measuring instants for determination of characteristic value data.

In one form of embodiment of the invention it is specified that:
the first parameter data of an operating means include the open-circuit voltage of the operating means and/or the short-circuit voltage of the operating means and/or data, which are determined by visual inspection, of the operating means.

In one form of embodiment of the invention it is specified that:
the characteristic value data are detected in situ at the respective operating means.

In one form of embodiment of the invention it is specified that:
the second parameter data of an operating means include the voltage level of the operating means and/or the costs for operating means exchange and/or the reaction times of service personnel and/or the topology of those sections of the system which are connected with the operating means and/or the supply reliability of those sections of the system which are connected with the operating means and/or the importance of the operating means for an end customer and/or the redundancy of those sections of the system which are connected with the operating means and/or the economic and/or ecological consequences of failure of the operating means.

In one form of embodiment of the invention it is specified that:
the second parameter data are stored in a central databank system or a network node databank.

In one form of embodiment of the invention it is specified that:
the determination of the expanded state index is carried out locally, in particular by a local evaluation device, or centrally, in particular by a superordinate evaluating device.

In one form of embodiment of the invention it is specified that:
the assessment of the stability and/or serviceability is carried out in accordance with the (N−x) criterion;

In that case, N is the number of operating means in the electrical system and x the number of those operating means at which a failure of the operating or functional capability occurs. The (N−x) criterion is fulfilled when in the case of failure of x operating means an unrestricted functional capability of the electrical system remains.

In one form of embodiment of the invention it is specified that:
fulfillment of the (N−x) criterion is checked in dependence on time tin that a function f(t+Δt) for prediction of the anticipated network state is used.

In one form of embodiment of the invention it is specified that:
at least one of the operating means and/or one of the network nodes includes a data interface for an SCADA system (Supervisory Control and Data Acquisition).

In one form of embodiment of the invention it is specified that:
the handling recommendations include intervention in the network topology and/or switching-on of at least one operating means and/or switching-off of at least one operating means and/or optimised capacity utilisation of the operating means and/or an optimised maintenance concept and/or an optimised repair concept and/or operation of the operating means for improved stability and/or serviceability.

In one form of embodiment of the proposed system it is specified that:
the control system is constructed in such a way that it can perform one of the proposed methods.

One of the proposed methods can be performed, for example, by each of the proposed systems.

Each of the proposed systems can, for example, be constructed in such a way or serve or be suitable for such a purpose that it executes or can execute one of the proposed methods.

The explanations with respect to one of the aspects of the invention, particularly with respect to individual features of that aspect, also analogously apply in corresponding manner to the other aspects of the invention.

Forms of embodiment of the invention are explained in more detail in the following by way of example with reference to the accompanying drawings. However, the individual features evident therefrom are not restricted to the individual forms of embodiment, but can be connected and/or combined with further above-described individual features and/or with individual features of other forms of embodiment. The details in the drawings are to be understood as only explanatory, but not limiting. The reference symbols contained in the claims are not to restrict the scope of protection of the invention in any way, but refer merely to the forms of embodiment shown in the drawings.

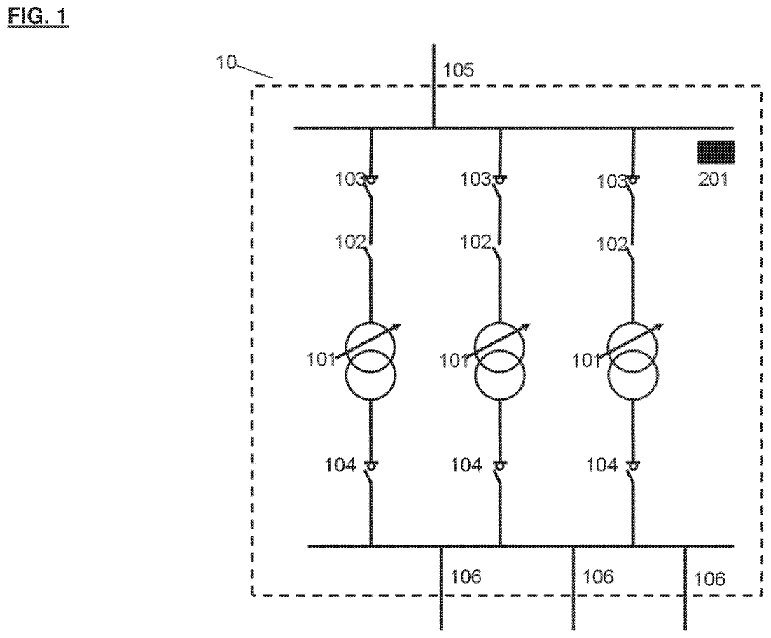

A preferred form of embodiment of a network node 10 of an energy supply network, which, for example, stands for an electrical system for energy supply, is schematically illustrated in FIG. 1. The network node 10 includes a feed line 105 from a superordinate or supplying mains, various isolating switches 103, 104 and power switches 102 as well as three regulable power transformers 101, which are connected not only at the input side, but also at the output side with the isolating switches 103, 104 and the power switches 102. In addition, by way of example three output paths 106 for supply of downstream energy supply networks are depicted.

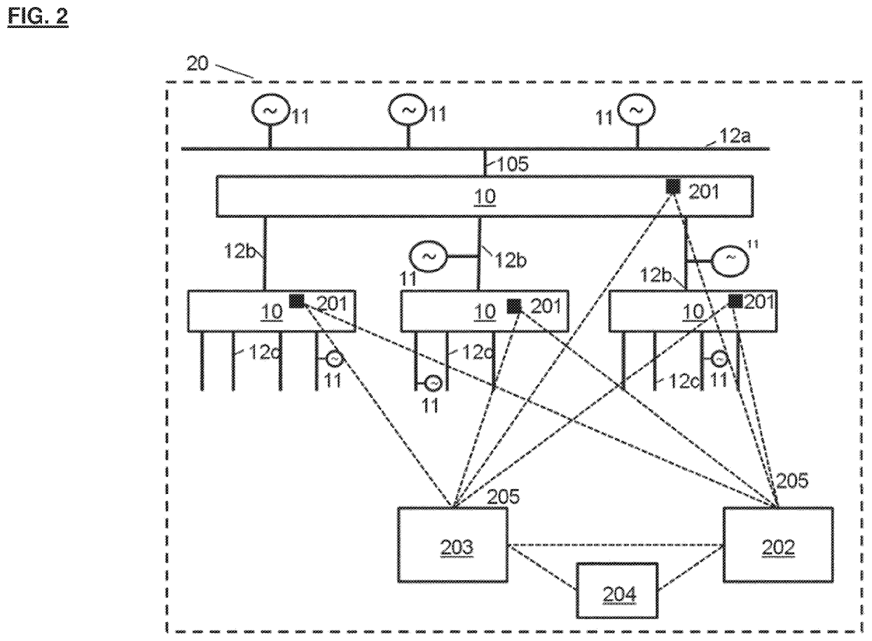

A preferred form of embodiment of the system 20 for energy supply or of the energy supply network 20 is schematically illustrated in FIG. 2. Energy supply networks are, in general, of hierarchical construction, since transmission and distribution of energy to and on different voltage planes takes place. Operating means used for power supply of consumers (not illustrated) are, inter alia, electrical current lines 12a, 12b, 12c of the respective network plane, constructed as overhead lines or subterranean cables, generating units or generators 11, such as, for example, power stations or systems for generation of energy from regenerative sources, and the transformers 101, power switches 102 and isolating switches 103, 104 present in the network nodes 10.

Each network node 10 includes a local evaluating unit 201 for detection, evaluation and communication of operating means data and environmental data. The data detected and processed by the individual local evaluating devices 201 are communicated by way of bidirectional communication lines 205 not only to a central databank system 203, but also to a superordinate SCADA (Supervisory Control and Data Acquision) system 202. Communication between the SCADA system 202 and the central databank system 203 is possible by way of a further bidirectional communication line. In addition, the energy supply network 20 includes a superordinate evaluating device 204, which generates handling recommendations for optimised network operational management from data of the central databank system 203 as well as current operating data made available by the SCADA system 202. The local evaluating devices 201, the SCADA system 202, the central databank system 203, the superordinate evaluating device 204 and the communication lines 205 together form a control system 200 of the energy supply network 20.

The superordinate evaluating device 204 is constructed in such a way that it can perform a preferred form of embodiment of a method for usage planning of operating means of the energy supply network 20. The method is based on determination of expanded state indices, for the individual operating means, and on combining and evaluation of the expanded state indices. A handling recommendation for optimised operational management of the energy supply network 20 is delivered on the basis of this evaluation.

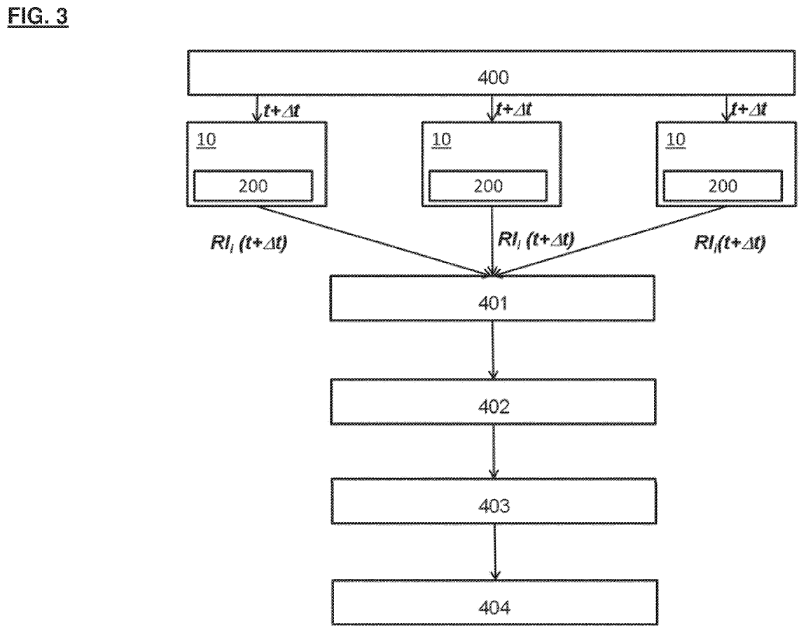

The preferred form of embodiment of the method, which is performed by the control system 200, is schematically illustrated in FIG. 3.

A future instant t+Δt is predetermined in a step 400. This is carried out, for example, by the superordinate evaluating device 204, which sends the future instant t+Δt by way of the SCADA system 202 to the local evaluating devices 201.

Expanded state indices RIᵢ=1, 2, 3) for the operating means 101, 102, 103, 104 of the respective network node 10 are then determined, by way of example, for the three network nodes 10 of FIG. 2 in a step 200. Determination of the expanded state indices RIᵢ can be carried out either directly at the respective operating means 101 . . . 104 by the local evaluating devices 201 or centrally by the superordinate evaluating device 204.

If the expanded state indices RIᵢ are determined by the superordinate evaluating device 204 (not illustrated in FIG. 3) raw data or prepared data series are made available by means of the communication connections 205 to the superordinate evaluating device 204.

If determination of the expanded state indices RIᵢ is carried out by the local evaluating devices 201 the determined expanded state indices RIᵢ are communicated in a step 401 by means of the communication connections 205 to the superordinate evaluating device 204.

In a step 402, a predictive assessment of stability and serviceability of the energy supply network 20 for the predetermined future instant t+Δt is carried out by the superordinate evaluating device 204 on the basis of a computation program for modelling, analysis and simulation of energy supply systems. For that purpose, a prediction of the anticipated state of the energy supply network 20 for the future instant t+Δt is carried out, with the help of known methods for load flow computation and stability analysis, by way of the communicated expanded state indices RIᵢ. In addition, information with respect to current operating data or other information from the SCADA system 202 can be also included in the prediction. A method for load flow computation and stability analysis is described in, for example, the printed work FENG H. ET AL, ‘Intelligent Control of On-Load Tap-Changer Based on Voltage Stability Margin Estimation Using Local Measurements’, published in the context of the CIGRE SESSION 2016. The content of this printed work is hereby included, by reference, in this application.

In a step 403, a predicted assessment of stability or serviceability of the energy supply network 20 for the future instant t+Δt is carried out on the basis of the (N−x) criterion, wherein N is the number of the operating means 101 . . . 104 in the energy supply network 20 and x describes the number of those operating means 101 . . . 104 at which a failure of operating or functional capability occurs. The (N−x) criterion is fulfilled if in the case of failure of x operating means an unrestricted functional capability of the energy supply network 20 is maintained. Definition and use of the (N−x) criterion are described in, for example, the article by KAPTUE KAMGA A., ‘Regelzonenübergreifendes Netzengpassmanagement mit optimalen Topologiemassnahmen’, Wuppertal 2009, Chapter 2.4. The content of this chapter is hereby included in this application by reference.

Handling recommendations with respect to network operation are generated in a step 404 by the superordinate evaluating device 204 on the basis of the predicted assessment. These handling recommendations can include, for example, interventions in the network topology and/or switching-on of at least one operating means 101 . . . 104, 105, 106 and/or switching-off of at least one operating means 101 . . . 106 and/or optimised capacity utilisation of the operating means 101 . . . 106 and/or an optimised maintenance concept and/or or an optimised repair concept and/or operation of the operating means 101 . . . 106 for improved stability and/or operation of the operating means 101 . . . 106 for improved serviceability. Advantageously, the generated handling recommendations are made available to the operator by means of a man/machine interface, for example in the form of a visualisation and user interface. Moreover, it is conceivable for the superordinate evaluating device 204 to co-operate with an e-mail client or an e-mail program and for the generated handling recommendations to be automatically sent to a predetermined receiver circle.

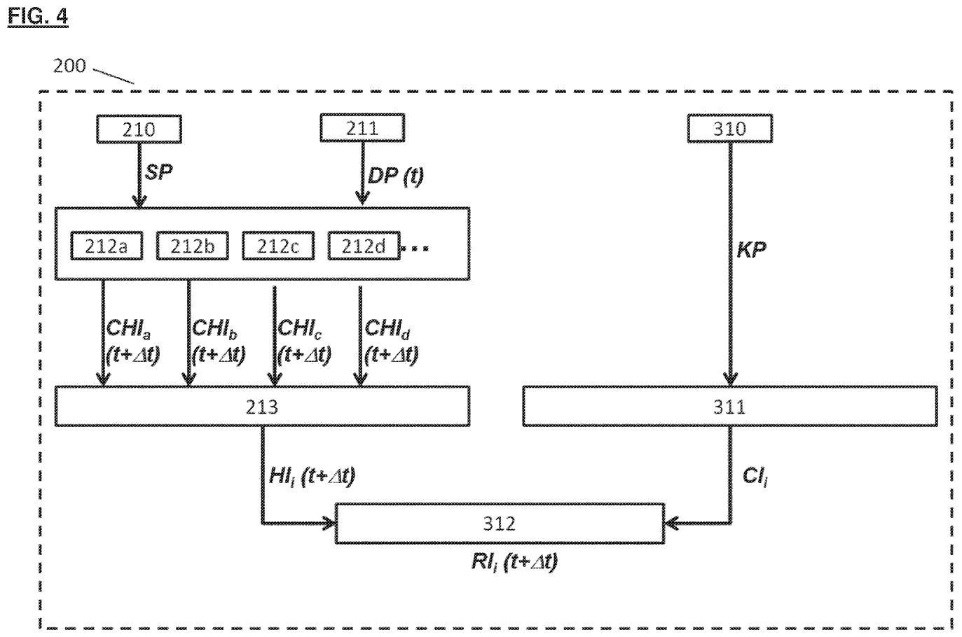

A preferred form of embodiment of the step 200 for, for example, the operating means consisting of transformer 101 is schematically illustrated in FIG. 4. Analogously thereto the creation of an expanded state index for further operating means such as, for example, overhead lines or subterranean cables or switching devices can be carried out.

Initially, the transformer 101 is subdivided into relevant physical risk groups (for example mechanics, thermics, dielectrics, tap changers, bushings, cooling as well as tank and accessories). First parameter data SP, which describe the technical nature of the operating means, are determined in a step 210. The determination of the first parameter data SP can be carried out automatically by the respective local evaluating device 201 and/or manually by a user and/or on the basis of freely formable numerical and/or logical linkage specifications and/or by processing of hazy input variables with use of fuzzy logic rules and/or by means probabilistic methods. First parameter data SP can thus include, for example, not only directly detected characteristic data of an operating means (for example, rated performance of a transformer 101), but also variables detected on the basis of measurement values (for example, evaluations from off-line DGA analyses).

Characteristic value data DP(t) describing the current technical state of the operating means 101 are continuously detected in a step 211. These characteristic value data DP(t) include, for example, load current, temperature of the transformer insulating oil (hot-spot temperature), ambient temperature, instantaneous performance of the transformer 101 referred to its rated performance, oil filling states, mechanically acting forces or other data made available by way of sensors or monitoring devices. Detection of the characteristic value data DP(t) is advantageously carried out automatically by the local evaluating device 201 on the basis of freely formable numerical and/or logical linkage specifications. In addition, processing of hazy input variables with use of fuzzy logic rules or fuzzy logic methods and/or probabilistic methods is advantageously possible. Characteristic value data DP(t) can thus include not only directly detected measurement values (for example ambient temperature), but also variables calculated on the basis of measurement values (for example hot-spot temperature).

Determination of the first parameter data SP and the characteristic value data DP(t) is described in, for example, the publication CIGRE WORKING GROUP A2.18, ‘Life Management Techniques for Power Transformer’, CIGRE, June 2003, Chapter 6, and the Publication CIGRE WORKING GROUP A2.44 ‘Guide on Transformer Intelligent Condition Monitoring (TCIM) Systems’, CIGRE, September 2015, Chapter 4, the content of which is inserted here by reference. The content of this chapter is thus incorporated in this application by reference.

The steps 210 and 211 are preferably carried out in parallel.

Moreover, it is characteristic for parameter data and characteristic value data of the operating means that the scanning rates between two measuring instants for determination of parameter data are greater by several orders or magnitude than the scanning rates between two measuring instants for determination of characteristic value data.

A corresponding predicted overall state CH_{b}, CHI_{c}, CHI_{d}, . . . is determined for each physical risk group in a corresponding step 212a, 212b, 212c, 212d, . . . from the first parameter data SP and the characteristic value data DP(t) as well as at the future instant t+Δt.

For that purpose, at least one predicted state value is determined in dependence on time for each risk group based on at least one corresponding mathematical rule. These mathematical rules include, for example, ageing models of the paper insulation of the transformer, temperature models for heating up and temperature plot in the transformer, rules for modelling the mechanical load in the transformer, rules for TGA analysis and other prediction models for the respective risk groups of the operating means. Appropriate prediction models are described in, for example, the publication CIGRE WORKING GROUP A2.18, ‘Life Management Techniques for Power Transformer’, CIGRE June 2003, Chapter 6. The content of this chapter is hereby included in this application by reference.

Each predicted state value CP is calculated in accordance with the following equation:

CP(t+Δt)_{n,m}=f_{n,m}(DP(t),SP)

In this equation, m is the index for the respective physical risk group under consideration and n is the index for the respective predicted state value of the risk group m.

The corresponding predicted overall state CHIₘ is calculated for each risk group m in accordance with the following equation:

$${CHI ( t + Δ t )}_{Average . m} = \frac{{\sum }_{n = 1} ( {WCP}_{n , m} * {CP ( t + Δ t )}_{n , m} )}{{\sum }_{n = 1} ( {WCP}_{n , m} * {CP}_{max} )} * 100 \%$$

In this equation, WCP_{n,m} is a weighting factor in which 0≤WCP_{n,m}≤1.

The steps 212a, 212b, 212c, 212d are preferably executed in parallel.

A predicted health index HIᵢ of the operating means is calculated in a step 213 from the predicted overall states CHIₘ of the physical risk groups m in accordance with the following equation:

$$H {I ( t + Δ t )}_{average , i} = {\sum }_{m = 1} {WHI}_{m} * {CHI ( t + Δ t )}_{Average , m} [ \% ]$$

In this equation, i is the index for the respective operating means under consideration and WHIₘ is a weighting factor in which 0≤WHIₘ≤1.

The weighting factors WHIₘ can in that case be based on empirical data and/or experience and/or technical considerations and can be ascertained, for example, on the part of the expert assessor or user or apparatus owner or apparatus manufacturer.

Second parameter data KP, which describe the relevance of the respective operating means in comparison with the remaining operating means, are determined in a step 310. Second parameters KP are, for example, procurement costs of the operating means, performance of the operating means, geographical position and accessibility, manufacturer, costs for operating means exchange, network topology, supply reliability, importance of the supplied customers, economic consequences of a mains failure, influence of a mains failure on the environment, empirically determined failure probabilities, etc. Determination of the second parameter data KP can be carried out automatically by the local evaluating device 201 and/or manually by a user and/or on the basis of freely formable numerical and/or logical linkage specifications and/or by processing of hazy input characteristic values and/or by use of fuzzy logic rules and/or probabilistic methods.

A criticality index CIᵢ for the respective operating means i is computed in a step 311 from the second parameter data KP in accordance with the following equation:

$${CI}_{Average , i} = {\sum }_{n = 1} {WKP}_{n} * {KP}_{n}$$

In this equation, n is the index for the individual second parameter data and WKPₙ is a weighting factor in which 0≤WKPₙ≤1.

The weighting factors WKPₙ can in that case be based on empirical data and/or experience and/or technical considerations and can be ascertained, for example, on the part of the expert assessor or user or apparatus owner or apparatus manufacturer.

The predicted health index HIᵢ and the criticality index CIᵢ of the respective operating means i in an expanded state index RIᵢ can be carried out in a step 312 in accordance with the following equation:

RIᵢ(t+Δt)=HI_{average,i}(t+Δt)*CI_{Average,i}

The above-mentioned steps 210 to 312 are repeated for all operating means of the energy supply network 20 until an expanded state index is present for every operating means.

Below is a listing of reference numerals used herein:
10 network nodes
101 regulable transformer, operating means
102 power switch, operating means
103 first isolating switch, operating means
104 second isolating switch, operating means
105 feed line, operating means
106 shunt line, operating means
11 generator, operating means
12a, 12b, 12c current line, operating means
20 electrical system, energy supply network
200 control system
201 local evaluating device
202 SCADA system
203 central databank system
204 superordinate evaluating device
205 bidirectional communication lines
CHI predicted overall state of a physical risk group
CI criticality index
CP predicted state value of a physical risk group
DP characteristic value data
HI health index
KP second parameter data
m, n indices
RI expanded state index
SP first parameter data
t+Δt future instant
WCP weighting factor
WHI weighting factor
WKP weighting factor

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for usage planning of electrical operating equipment of an electrical system for supplying energy, wherein in the method:
a future instant is predetermined;
for each of the electrical operating equipment:
first parameter data describing the technical nature of the respective electrical operating equipment are determined;
second parameter data describing the relevance of the respective electrical operating equipment in comparison with the remaining electrical operating equipment are determined;
characteristic value data of the respective electrical operating equipment are determined;
a predicted state index representing a predicted state of the respective electrical operating equipment for the future instant is determined using a first mathematical rule from the first parameter data and the characteristic value data of the respective electrical operating equipment;
a criticality index is determined using a second mathematical rule from the second parameter data of the respective electrical operating equipment;
an expanded state index representing a predicted risk analysis of the respective electrical operating equipment is determined using a third mathematical rule from the state index and the criticality index of the respective electrical operating equipment; and
for the electrical system
a predictive assessment of stability and/or serviceability for the future instant is carried out on the basis of the expanded state index.

2. The method according to claim 1, wherein:
an adapted usage planning of the electrical operating equipment is produced from the predictive assessment; and
handling recommendations for operating management of the electrical system are produced on the basis of the usage planning.

3. The method according to claim 1, wherein:
physical risk groups comprising mechanics and/or thermics and/or dielectrics and/or a tap changer and/or a bushing and/or cooling and/or further groups are formed for creating the first mathematical rule;
specific mathematical models for state analysis and characterisation are used for forming the individual risk groups; and
the first mathematical rule comprises a thermal ageing model of a transformer or of an overhead line and/or rules for modelling a mechanical load in a transformer and/or rules for DGA analysis.

4. The method according to claim 1, wherein:
characteristic values corresponding to characteristic value data of a transformer comprise a load current, and/or a temperature of transformer insulating oil, and/or an ambient temperature, and/or a gas concentration in the transformer insulating oil, and/or an instantaneous performance of the transformer.

5. The method according to claim 1, wherein:
scanning rates between two measuring instants for determination of parameter data, comprising at least one of the first parameter data and the second parameter data, are greater by several orders or magnitude than the scanning rates between two measuring instants for determination of the characteristic value data.

6. The method according to claim 1, wherein:
the first parameter data of the respective electrical operating equipment comprise an open-circuit voltage of the respective electrical operating equipment and/or a short-circuit voltage of the respective electrical operating equipment and/or data, which are determined by visual inspection, of the respective electrical operating equipment;
the second parameter data of the respective electrical operating equipment comprise a voltage level of the respective electrical operating equipment and/or costs for the respective electrical operating equipment exchange and/or reaction times of service personnel and/or a topology of sections of the electrical system connected with the respective electrical operating equipment and/or a supply reliability of the sections of the electrical system connected with the respective electrical operating equipment and/or an importance of the respective electrical operating equipment for an end customer and/or a redundancy of the sections of the electrical system connected with the respective electrical operating equipment and/or economic and/or ecological consequences of failure of the respective electrical operating equipment.

7. The method according to claim 1, wherein:
the second parameter data are stored in a central databank system or a network node databank.

8. The method according to claim 1, wherein:
the predictive assessment of the stability and/or the serviceability is carried out in accordance with the (N−x) criterion; and
a fulfillment of the (N−x) criterion is checked in dependence on time tin that a function for prediction of the anticipated network state is used.

9. The method according to claim 2, wherein:
the handling recommendations comprise intervention in a network topology and/or switching-on of at least one of the electrical operating equipment and/or switching-off of at least one of the electrical operating equipment and/or optimised capacity utilisation of the electrical operating equipment and/or an optimised maintenance concept and/or an optimised repair concept and/or operation of the electrical operating equipment for improved stability and/or serviceability.

10. An electrical system for supplying energy, the electrical system comprising:
a plurality of electrical operating equipment; and
a control system, which is coupled to the electrical operating equipment,
wherein the control system configured to execute a method for usage planning of the electrical operating equipment, wherein in the method the control system:
predetermines a future instant;
for each of the electrical operating equipment:
determines first parameter data describing a technical nature of the respective electrical operating equipment;
determines second parameter data describing a relevance of the respective electrical operating equipment compared with the remaining electrical operating equipment;
determines characteristic value data of the respective electrical operating equipment;
determines a predicted state index, which represents a predicted state of the respective electrical operating equipment for the future instant, using a first mathematical rule from the first parameter data and the characteristic value data of the respective electrical operating equipment;
determines a criticality index using a second mathematical rule from the second parameter data of the respective electrical operating equipment;
determines an expanded state index, which represents a predicted risk analysis of the respective electrical operating equipment, with using a third mathematical rule from the predicted state index and the criticality index of the respective electrical operating equipment;
for the electrical system:
performs a predictive assessment of a stability and/or a serviceability for the future instant on the basis of the expanded state index.

11. The electrical system according to claim 10, wherein
the control system is so constructed that it can perform a method configured in accordance with claim 1.

12. The electrical system for supplying energy, wherein the electrical operating equipment comprises a transformer, and/or a power switch, and/or, an isolating switch, and/or a power line.
